(19) United States
(12) Patent Application Publication
(10) Pub. No.: US 2025/0097928 A1
(43) Pub. Date: Mar. 20, 2025

(54) SERVICE-BASED TRANSMIT ENERGY ALLOCATION AMONG DIFFERENT RADIOS

(71) Applicant: QUALCOMM Incorporated, San Diego, CA (US)

(72) Inventors: Huang LOU, Santee, CA (US); Arnaud MEYLAN, San Diego, CA (US); Farhad MESHKATI, San Diego, CA (US); Lin LU, San Diego, CA (US); Jagadish NADAKUDUTI, Bermuda Dunes, CA (US); Reza SHAHIDI, La Jolla, CA (US)

(21) Appl. No.: 18/889,714

(22) Filed: Sep. 19, 2024

Related U.S. Application Data
(60) Provisional application No. 63/584,150, filed on Sep. 20, 2023.

(51) Int. Cl. H04W 72/044; H04W 52/32; H04W 52/36

(52) U.S. Cl. CPC H04W 72/0473; H04W 52/32; H04W 52/367

(57) ABSTRACT

Techniques and apparatus for service-based transmit energy allocation are described. An example method that may be performed by a wireless communication device includes obtaining reserve information associated with services allocated to a set of antenna groups. Each antenna group is associated with at least one radio corresponding to at least one radio access technology (RAT). A reserve is determined for each radio, based at least in part on the reserve information, a set of services mapped to the radio, and a respective state associated with each of the set of services. A signal(s) is transmitted for at least one service using at least one radio associated with the at least one service and a transmit power determined based at least in part on a radio frequency (RF) exposure limit associated with the at least one radio and the reserve for the at least one radio.

### CROSS-REFERENCE TO RELATED APPLICATION(S)

The present application for patent claims the benefit of and priority to U.S. Provisional Application No. 63/584,150, filed Sep. 20, 2023, which is expressly incorporated by reference herein in its entirety as if fully set forth below and for all applicable purposes.

### INTRODUCTION

### Field of the Disclosure

Aspects of the present disclosure relate to wireless communications, and more particularly, to radio frequency (RF) exposure compliance.

### DESCRIPTION OF RELATED ART

Wireless communication systems are widely deployed to provide various telecommunication services such as telephony, video, data, messaging, broadcasts, etc. Modem wireless communication devices (such as smartphones) are generally mandated to meet radio frequency (RF) exposure limits set by domestic and international standards and regulations. To ensure compliance with the standards, such devices may undergo an extensive certification process prior to being shipped to market. To ensure that a wireless communication device complies with an RF exposure limit, techniques have been developed to enable the wireless communication device to assess RF exposure from the wireless communication device and adjust the transmission power of the wireless communication device accordingly for compliance.

### SUMMARY

The systems, methods, and devices of the disclosure each have several aspects, no single one of which is solely responsible for its desirable attributes. Without limiting the scope of this disclosure as expressed by the claims that follow, some features will now be discussed briefly. After considering this discussion, and particularly after reading the section entitled “Detailed Description,” one will understand how the features of this disclosure provide advantages that include improved wireless communication performance and/or efficient energy allocation among radios.

Certain aspects of the subject matter described in this disclosure can be implemented in a method for wireless communication by a wireless device. The method generally includes obtaining reserve information associated with a plurality of services allocated to a set of antenna groups. Each antenna group of the set of antenna groups is associated with one or more radios corresponding to one or more radio access technologies (RATs). The method also includes determining a reserve for each of the one or more radios, based at least in part on the reserve information, a set of services of the plurality of services mapped to the radio, and a respective state associated with each of the set of services. The method further includes transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

Certain aspects of the subject matter described in this disclosure can be implemented in an apparatus for wireless communication. The apparatus includes one or more memories collectively storing computer-executable instructions, and one or more processors coupled to the one or more memories. The one or more processors are collectively configured to execute the computer-executable instructions to cause the apparatus to perform an operation. The operation includes obtaining reserve information associated with a plurality of services allocated to a set of antenna groups. Each antenna group of the set of antenna groups is associated with one or more radios corresponding to one or more radio access technologies (RATs). The operation also includes determining a reserve for each of the one or more radios, based at least in part on the reserve information, a set of services of the plurality of services mapped to the radio, and a respective state associated with each of the set of services. The operation further includes transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

Certain aspects of the subject matter described in this disclosure can be implemented in an apparatus for wireless communication. The apparatus generally includes means for obtaining reserve information associated with a plurality of services allocated to a set of antenna groups. Each antenna group of the set of antenna groups is associated with one or more radios corresponding to one or more radio access technologies (RATs). The apparatus also includes means for determining a reserve for each of the one or more radios, based at least in part on the reserve information, a set of services of the plurality of services mapped to the radio, and a respective state associated with each of the set of services. The apparatus further includes means for transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

Certain aspects of the subject matter described in this disclosure can be implemented in a computer-readable medium. The computer-readable medium has instructions stored thereon, which when executed by one or more processors, cause the one or more processors to perform an operation. The operation generally includes obtaining reserve information associated with a plurality of services allocated to a set of antenna groups. Each antenna group of the set of antenna groups is associated with one or more radios corresponding to one or more radio access technologies (RATs). The operation also includes determining a reserve for each of the one or more radios, based at least in part on the reserve information, a set of services of the plurality of services mapped to the radio, and a respective state associated with each of the set of services. The operation further includes causing transmission of one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

To the accomplishment of the foregoing and related ends, the one or more aspects comprise the features hereinafter fully described and particularly pointed out in the claims. The following description and the appended drawings set forth in detail certain illustrative features of the one or more aspects. These features are indicative, however, of but a few of the various ways in which the principles of various aspects may be employed.

### BRIEF DESCRIPTION OF THE DRAWINGS

So that the manner in which the above-recited features of the present disclosure can be understood in detail, a more particular description, briefly summarized above, may be had by reference to aspects, some of which are illustrated in the drawings. It is to be noted, however, that the appended drawings illustrate only certain aspects of this disclosure and are therefore not to be considered limiting of its scope, for the description may admit to other equally effective aspects.

FIG. 1 is a block diagram conceptually illustrating an example wireless communication network, in accordance with certain aspects of the present disclosure.

FIG. 2 is a block diagram conceptually illustrating a design of an example base station (BS) and user equipment (UE), in accordance with certain aspects of the present disclosure.

FIG. 3 is a block diagram of an example radio frequency (RF) transceiver, in accordance with certain aspects of the present disclosure.

FIGS. 4A, 4B, and 4C are graphs illustrating examples of transmit powers over time in compliance with a time-averaged RF exposure limit, in accordance with certain aspects of the present disclosure.

FIG. 5 is a block diagram illustrating an example grouping of multiple antennas of a wireless communication device.

FIG. 6 is a table illustrating example reserve information for a plurality of services for a plurality of antenna groups, in accordance with certain aspects of the present disclosure.

FIG. 7 is a table illustrating example real-time state information for a plurality of services, in accordance with certain aspects of the present disclosure.

FIG. 8 is a table illustrating an example of reserves mapped to radios of a plurality of antenna groups, in accordance with certain aspects of the present disclosure.

FIG. 9 is a flow diagram illustrating example operations for wireless communication by a wireless device, in accordance with certain aspects of the present disclosure.

FIG. 10 illustrates a communications device (e.g., a UE) that may include various components configured to perform operations for the techniques disclosed herein, in accordance with certain aspects of the present disclosure.

To facilitate understanding, identical reference numerals have been used, where possible, to designate identical elements that are common to the figures. It is contemplated that elements disclosed in one aspect may be beneficially utilized on other aspects without specific recitation.

### DETAILED DESCRIPTION

Aspects of the present disclosure provide apparatus, methods, processing systems, and computer-readable mediums for service-based transmit energy allocation among different radios.

A wireless communications device may support various services over multiple radios that operate according to different classes of radio access technologies (RATs), such as wireless wide area network (WWAN) access technologies (e.g., Long Term Evolution (LTE) and Fifth Generation New Radio (5G NR)), wireless local area network (WLAN) access technologies (e.g., Institute of Electrical and Electronics Engineers (IEEE) 802.11), Bluetooth access technologies (e.g., Bluetooth version 4.0 and other versions), non-terrestrial network (NTN) technologies (e.g., satellite communications), radio frequency identification (RFID) communications, device-to-device (e.g., sidelink) communications, and vehicle-to-everything (V2X) communications, as illustrative, non-limiting examples. Such services may include, for example, voice traffic, video traffic, gaming traffic, augmented or virtual reality traffic, video conferencing traffic, an internet-type service, WLAN peer-to-peer (P2P) traffic, cellular vehicle-to-everything (CV2X) traffic, hotspot WLAN traffic, RFID traffic, etc.

A wireless communications device that has multiple radios may be configured with a reserve that is allocated among the radios. For example, assuming the wireless communications device has a first radio and a second radio that are actively transmitting, the wireless communications device may allocate a first portion of the reserve to the first radio and a second portion of the reserve to the second radio. However, one issue that can arise with using multiple radios is that, in some cases, a radio (e.g., a higher priority radio) can request an exceedingly large amount of the reserve which can lead to other radio(s) being starved. In such cases, the performance of services that are mapped to the starved radio(s) may be reduced, impacting the performance of the wireless communications device.

Additionally, in certain cases, different radios of the wireless communications device may not belong to the same antenna group. In such cases, there may be situations in which a service is handed over from one antenna group (with an amount of reserve) to another antenna group (with a lower amount of reserve). However, if the current antenna group does not have a sufficient amount of reserve to support the service, the service can experience performance issues (e.g., reduced signal quality at the receiver, reduced throughput, higher latency, etc.).

In certain aspects described herein, a wireless communications device may evaluate radio frequency (RF) exposure compliance for multiple radios that support multiple radio access technologies (RATs) based at least in part on services that are mapped to the radios. For example, the wireless communications device may be configured with multiple minimum service reserves for each respective service supported by the wireless communication device, where each of the multiple minimum service reserves is associated with a respective RAT. The wireless communications device may allocate a portion of a reserve to each radio based on the services(s) mapped to the respective radio and the minimum service reserve associated with the service(s) and respective RAT for the radio. The wireless communication device may allocate transmit energy for three or more radios and/or among radios that communicate via different RATs based in part on the respective reserve portions for the radios.

The apparatus and methods for allocating transmit energy among radios described herein may facilitate improved wireless communication performance (e.g., improved signal quality at the receiver, lower latencies, higher throughput, etc.). For example, a wireless device may allocate reserves to the radios based on services mapped to the radios, such that each radio has at least a minimum service reserve available for the services mapped to the radio. Such an allocation may facilitate wireless communication performance by avoiding scenarios in which certain services are starved due to insufficient allocation of reserve(s).

As used herein, a radio may refer to a physical or logical transmission path associated with one or more active frequency bands, transceivers, and/or radio access technologies (RATs) (e.g., code division multiple access (CDMA), LTE, NR, IEEE 802.11, Bluetooth, etc.) used for wireless communications. For example, for uplink carrier aggregation in LTE and/or NR, each of the active component carriers used for wireless communications may be treated as a separate radio. Similarly, multi-band transmissions for IEEE 802.11 communications may be treated as separate radios for each band (e.g., 2.4 GHz, 5 GHz, or 6 GHz). As used herein, a “minimum reserve” or merely “reserve” may refer to a minimum level of transmit power allocated to one or more radios for a certain duration (e.g., a transmission occasion, a time window associated with a (time-averaged) RF exposure limit, or a portion thereof).

The following description provides examples of RF exposure compliance in communication systems, and is not limiting of the scope, applicability, or examples set forth in the claims. Changes may be made in the function and arrangement of elements discussed without departing from the scope of the disclosure. Various examples may omit, substitute, or add various procedures or components as appropriate. For instance, the methods described may be performed in an order different from that described, and various steps may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim. The word “exemplary” is used herein to mean “serving as an example, instance, or illustration.” Any aspect described herein as “exemplary” is not necessarily to be construed as preferred or advantageous over other aspects.

In general, any number of wireless networks may be deployed in a given geographic area. Each wireless network may support a particular radio access technology (RAT) and may operate on one or more frequencies. A RAT may also be referred to as a radio technology, an air interface, etc. A frequency may also be referred to as a carrier, a subcarrier, a frequency channel, a tone, a subband, etc. Each frequency may support a single RAT in a given geographic area in order to avoid interference between wireless networks of different RATs, or may support multiple RATs.

The techniques described herein may be used for various wireless networks and radio technologies. While aspects may be described herein using terminology commonly associated with 3G, 4G, and/or New Radio (e.g., 5G NR) wireless technologies, aspects of the present disclosure can be applied in other generation-based communication systems and/or to wireless technologies such as IEEE 802.11, 802.15, etc.

NR access may support various wireless communication services, such as enhanced mobile broadband (eMBB) targeting wide bandwidth (e.g., 80 MHz or beyond), millimeter wave (mmWave) targeting high carrier frequency (e.g., 24 GHz to 53 GHz or beyond), massive machine type communications MTC (mMTC) targeting non-backward compatible MTC techniques, and/or mission critical targeting ultra-reliable low-latency communications (URLLC). These services may include latency and reliability specifications. These services may also have different transmission time intervals (TTIs) to meet respective quality of service (QoS) specifications. In addition, these services may co-exist in the same subframe. NR supports beamforming, and beam direction may be dynamically configured. Multiple-input, multiple-output (MIMO) transmissions with precoding may also be supported, as may multi-layer transmissions. Aggregation of multiple cells may be supported.

The electromagnetic spectrum is often subdivided, based on frequency/wavelength, into various classes, bands, channels, etc. In 5G NR, two initial operating bands have been identified as frequency range designations FR1 (410 MHz-7.125 GHz) and FR2 (24.25 GHz-52.6 GHz). The frequencies between FR1 and FR2 are often referred to as mid-band frequencies. Although a portion of FR1 is greater than 6 GHz, FR1 is often referred to (interchangeably) as a “Sub-6 GHz” band in various documents and articles. A similar nomenclature issue sometimes occurs with regard to FR2, which is often referred to (interchangeably) as a “millimeter wave” band in documents and articles, despite being different from the extremely high frequency (EHF) band (30 GHz-300 GHz) which is identified by the International Telecommunications Union (ITU) as a “millimeter wave” band.

With the above aspects in mind, unless specifically stated otherwise, it should be understood that the term “sub-6 GHz” or the like if used herein may broadly represent frequencies that may be less than 6 GHz, may be within FR1, or may include mid-band frequencies. Further, unless specifically stated otherwise, it should be understood that the term “millimeter wave” or the like if used herein may broadly represent frequencies that may include mid-band frequencies, may be within FR2, or may be within the EHF band. Example Wireless Communication Network and Devices

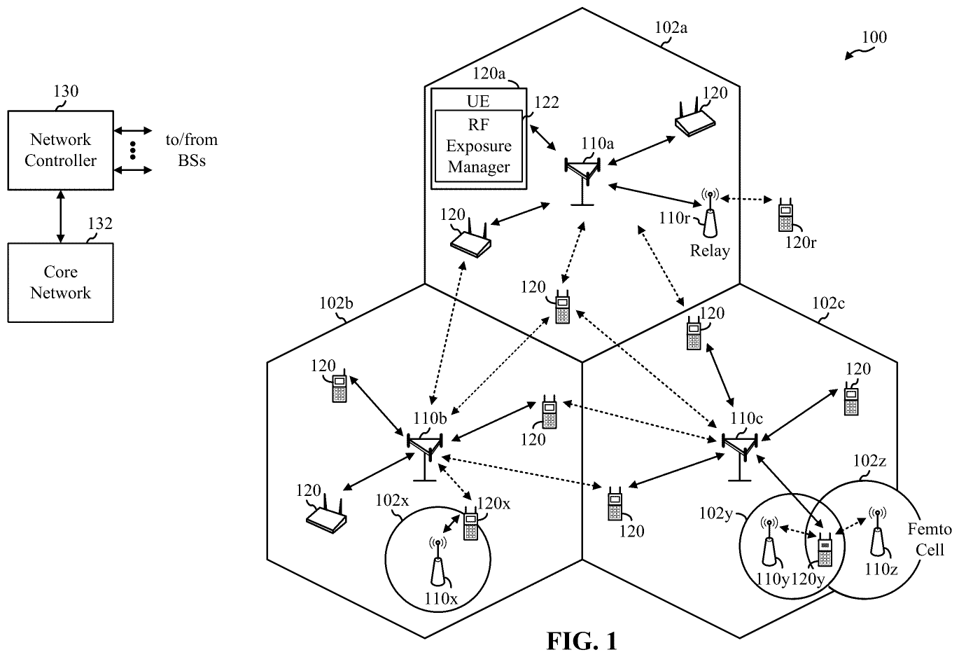

FIG. 1 illustrates an example wireless communication network 100 in which aspects of the present disclosure may be performed. For example, the wireless communication network 100 may be an NR system (e.g., a 5G NR network), an Evolved Universal Terrestrial Radio Access (E-UTRA) system (e.g., a 4G network), a Universal Mobile Telecommunications System (UMTS) (e.g., a 2G/3G network), or a code division multiple access (CDMA) system (e.g., a 2G/3G network), or may be configured for communications according to an IEEE standard such as one or more of the 802.11 standards, etc. As shown in FIG. 1, the UE 120a includes an RF exposure manager 122 that ensures RF exposure compliance using reserves allocated to radios per antenna group, in accordance with certain aspects of the present disclosure.

As illustrated in FIG. 1, the wireless communication network 100 may include a number of BSs 110a-z (each also individually referred to herein as BS 110 or collectively as BSs 110) and other network entities. A BS 110 may provide communication coverage for a particular geographic area, sometimes referred to as a “cell,” which may be stationary or may move according to the location of a mobile BS. In some examples, the BSs 110 may be interconnected to one another and/or to one or more other BSs or network nodes (not shown) in wireless communication network 100 through various types of backhaul interfaces (e.g., a direct physical connection, a wireless connection, a virtual network, or the like) using any suitable transport network. In the example shown in FIG. 1, the BSs 110a, 110b, and 110c may be macro BSs for the macro cells 102a, 102b, and 102c, respectively. The BS 110x may be a pico BS for a pico cell 102x. The BSs 110y and 110z may be femto BSs for the femto cells 102y and 102z, respectively. A BS may support one or multiple cells.

The BSs 110 communicate with UEs 120a-y (each also individually referred to herein as UE 120 or collectively as UEs 120) in the wireless communication network 100. The UEs 120 (e.g., 120x, 120y, etc.) may be dispersed throughout the wireless communication network 100, and each UE 120 may be stationary or mobile. Wireless communication network 100 may also include relay stations (e.g., relay station 110r), also referred to as relays or the like, that receive a transmission of data and/or other information from an upstream station (e.g., a BS 110a or a UE 120r) and sends a transmission of the data and/or other information to a downstream station (e.g., a UE 120 or a BS 110), or that relays transmissions between UEs 120, to facilitate communication between devices.

A network controller 130 may be in communication with a set of BSs 110 and provide coordination and control for these BSs 110 (e.g., via a backhaul). In certain cases, the network controller 130 may include a centralized unit (CU) and/or a distributed unit (DU), for example, in a 5G NR system. In some aspects, the network controller 130 may be in communication with a core network 132 (e.g., a 5G Core Network (5GC)), which provides various network functions such as Access and Mobility Management, Session Management, User Plane Function, Policy Control Function, Authentication Server Function, Unified Data Management, Application Function, Network Exposure Function, Network Repository Function, Network Slice Selection Function, etc.

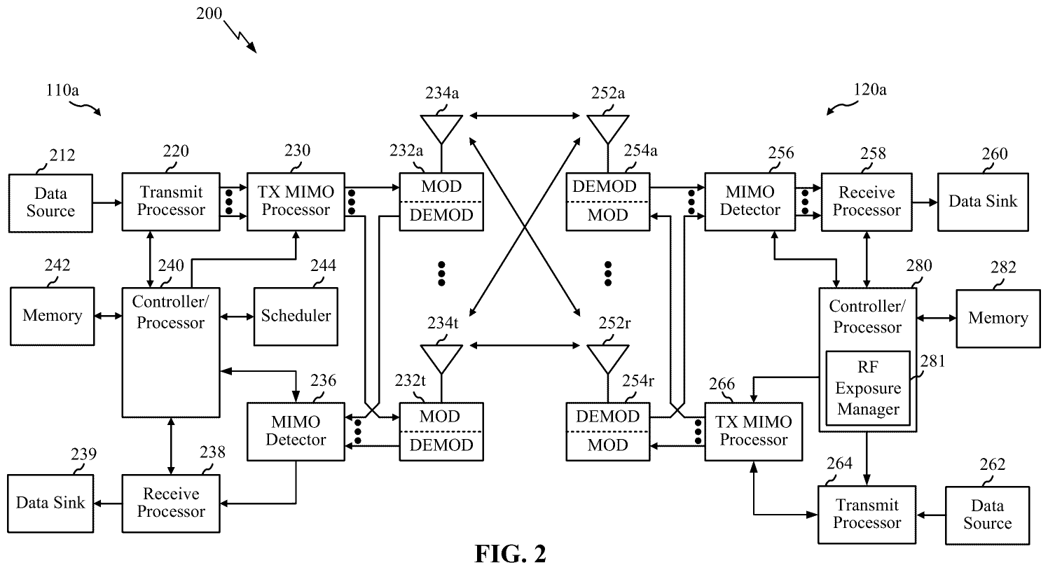

FIG. 2 illustrates example components of BS 110a and UE 120a (e.g., the wireless communication network 100 of FIG. 1), which may be used to implement aspects of the present disclosure.

At the BS 110a, a transmit processor 220 may receive data from a data source 212 and control information from a controller/processor 240. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), etc. The data may be for the physical downlink shared channel (PDSCH), etc. A medium access control (MAC)-control element (MAC-CE) is a MAC layer communication structure that may be used for control command exchange between wireless nodes. The MAC-CE may be carried in a shared channel such as a PDSCH, a physical uplink shared channel (PUSCH), or a physical sidelink shared channel (PSSCH).

The processor 220 may process (e.g., encode and symbol map) the data and control information to obtain data symbols and control symbols, respectively. The transmit processor 220 may also generate reference symbols, such as for the primary synchronization signal (PSS), secondary synchronization signal (SSS), PBCH demodulation reference signal (DMRS), and channel state information reference signal (CSI-RS). A transmit (TX) multiple-input multiple-output (MIMO) processor 230 may perform spatial processing (e.g., precoding) on the data symbols, the control symbols, and/or the reference symbols, if applicable, and may provide output symbol streams to the modulators (MODs) in transceivers 232a-232t. Each modulator in transceivers 232a-232t may process a respective output symbol stream (e.g., for orthogonal frequency division multiplexing (OFDM), etc.) to obtain an output sample stream. Each of the transceivers 232a-232t may further process (e.g., convert to analog, amplify, filter, and upconvert) the output sample stream to obtain a downlink signal. Downlink signals from the transceivers 232a-232t may be transmitted via the antennas 234a-234t, respectively.

At the UE 120a, the antennas 252a-252r may receive the downlink signals from the BS 110a and may provide received signals to the demodulators (DEMODs) in transceivers 254a-254r, respectively. Each demodulator in transceivers 254a-254r may condition (e.g., filter, amplify, downconvert, and digitize) a respective received signal to obtain input samples. Each demodulator (DEMOD) may further process the input samples (e.g., for OFDM, etc.) to obtain received symbols. A MIMO detector 256 may obtain received symbols from all the demodulators in transceivers 254a-254r, perform MIMO detection on the received symbols if applicable, and provide detected symbols. A receive processor 258 may process (e.g., demodulate, deinterleave, and decode) the detected symbols, provide decoded data for the UE 120a to a data sink 260, and provide decoded control information to a controller/processor 280.

On the uplink, at UE 120a, a transmit processor 264 may receive and process data (e.g., for the physical uplink shared channel (PUSCH)) from a data source 262 and control information (e.g., for the physical uplink control channel (PUCCH)) from the controller/processor 280. The transmit processor 264 may also generate reference symbols for a reference signal (e.g., for the sounding reference signal (SRS)). The symbols from the transmit processor 264 may be precoded by a TX MIMO processor 266 if applicable, further processed by the modulators (MODs) in transceivers 254a-254r (e.g., for single-carrier frequency division multiplexing (SC-FDM), etc.), and transmitted to the BS 110a. At the BS 110a, the uplink signals from the UE 120a may be received by the antennas 234, processed by the demodulators in transceivers 232a-232t, detected by a MIMO detector 236 if applicable, and further processed by a receive processor 238 to obtain decoded data and control information sent by the UE 120a. The receive processor 238 may provide the decoded data to a data sink 239 and the decoded control information to the controller/processor 240.

The memories 242 and 282 may store data and program codes for BS 110a and UE 120a, respectively. A scheduler 244 may schedule UEs for data transmission on the downlink and/or uplink.

Antennas 252, processors 266, 258, 264, and/or controller/processor 280 of the UE 120a and/or antennas 234, processors 220, 230, 238, and/or controller/processor 240 of the BS 110a may be used to perform the various techniques and methods described herein. As shown in FIG. 2, the controller/processor 280 of the UE 120a has an RF exposure manager 281 that may be representative of the RF exposure manager 122, according to aspects described herein. Although shown at the controller/processor, other components of the UE 120a and BS 110a may be used to perform the operations described herein.

NR may utilize orthogonal frequency division multiplexing (OFDM) with a cyclic prefix (CP) on the uplink and downlink. NR may support half-duplex operation using time division duplexing (TDD). OFDM and single-carrier frequency division multiplexing (SC-FDM) partition the system bandwidth into multiple orthogonal subcarriers, which are also commonly referred to as tones, bins, etc. Each subcarrier may be modulated with data. Modulation symbols may be sent in the frequency domain with OFDM and in the time domain with SC-FDM. The spacing between adjacent subcarriers may be fixed, and the total number of subcarriers may be dependent on the system bandwidth. The minimum resource allocation, called a resource block (RB), may be 12 consecutive subcarriers. The system bandwidth may also be partitioned into subbands. For example, a subband may cover multiple RBs. NR may support a base subcarrier spacing (SCS) of 15 kHz, and other SCSs may be defined with respect to the base SCS (e.g., 30 kHz, 60 kHz, 120 kHz, 240 kHz, etc.).

While the UE 120a is described with respect to FIGS. 1 and 2 as communicating with a BS and/or within a network, the UE 120a may be configured to communicate directly with/transmit directly to another UE 120, or with/to another wireless device without relaying communications through a network. In some aspects, the BS 110a illustrated in FIG. 2 and described above is an example of another UE 120. Example RF Transceiver

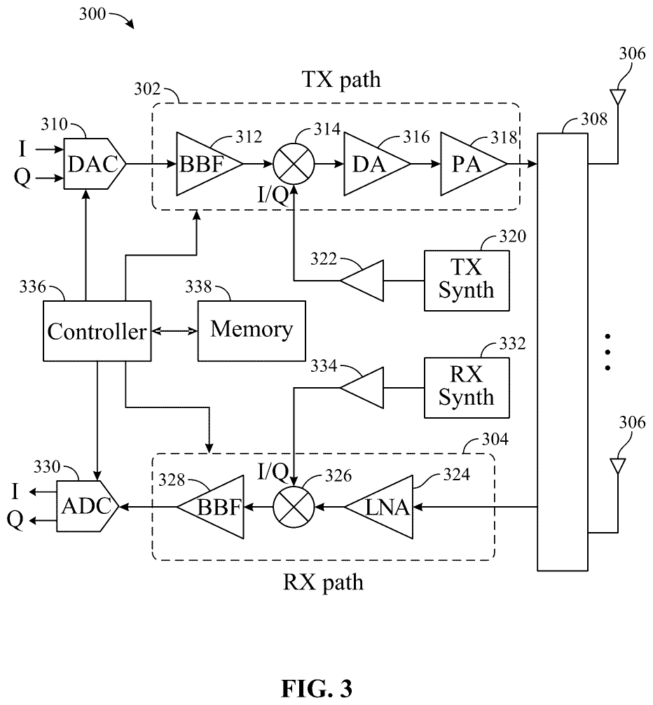

FIG. 3 is a block diagram of an example RF transceiver circuit 300, which may be used in any of the wireless devices described above, in accordance with certain aspects of the present disclosure. The RF transceiver circuit 300 includes at least one transmit (TX) path 302 (also known as a “transmit chain”) for transmitting signals via one or more antennas 306 and at least one receive (RX) path 304 (also known as a “receive chain”) for receiving signals via the antennas 306. When the TX path 302 and the RX path 304 share an antenna 306, the paths may be connected with the antenna via an interface 308, which may include any of various suitable RF devices, such as a switch, a duplexer, a diplexer, a multiplexer, and the like.

Receiving in-phase (I) or quadrature (Q) baseband analog signals from a digital-to-analog converter (DAC) 310, the TX path 302 may include a baseband filter (BBF) 312, a mixer 314, a driver amplifier (DA) 316, and a power amplifier (PA) 318. The BBF 312, the mixer 314, and the DA 316 may be included in one or more radio frequency integrated circuits (RFICs). The PA 318 may be external to the RFIC(s) for some implementations.

The BBF 312 filters the baseband signals received from the DAC 310, and the mixer 314 mixes the filtered baseband signals with a transmit local oscillator (LO) signal to convert the baseband signal of interest to a different frequency (e.g., upconvert from baseband to a radio frequency). This frequency conversion process produces the sum and difference frequencies between the LO frequency and the frequencies of the baseband signal of interest. The sum and difference frequencies are referred to as the “beat frequencies.” The beat frequencies are typically in the RF range, such that the signals output by the mixer 314 are typically RF signals, which may be amplified by the DA 316 and/or by the PA 318 before transmission by the antenna 306. While one mixer 314 is illustrated, several mixers may be used to upconvert the filtered baseband signals to one or more intermediate frequencies and to thereafter upconvert the intermediate frequency signals to a frequency for transmission.

The RX path 304 may include a low noise amplifier (LNA) 324, a mixer 326, and a baseband filter (BBF) 328. The LNA 324, the mixer 326, and the BBF 328 may be included in one or more RFICs, which may or may not be the same RFIC that includes the TX path components. RF signals received via the antenna 306 may be amplified by the LNA 324, and the mixer 326 mixes the amplified RF signals with a receive local oscillator (LO) signal to convert the RF signal of interest to a different baseband frequency (e.g., downconvert). The baseband signals output by the mixer 326 may be filtered by the BBF 328 before being converted by an analog-to-digital converter (ADC) 330 to digital I or Q signals for digital signal processing.

Certain transceivers may employ frequency synthesizers with a voltage-controlled oscillator (VCO) to generate a stable, tunable LO with a particular tuning range. Thus, the transmit LO may be produced by a TX frequency synthesizer 320, which may be buffered or amplified by amplifier 322 before being mixed with the baseband signals in the mixer 314. Similarly, the receive LO may be produced by an RX frequency synthesizer 332, which may be buffered or amplified by amplifier 334 before being mixed with the RF signals in the mixer 326.

A controller 336 may direct the operation of the RF transceiver circuit 300, such as transmitting signals via the TX path 302 and/or receiving signals via the RX path 304. The controller 336 may be a processor, a digital signal processor (DSP), an application specific integrated circuit (ASIC), a field programmable gate array (FPGA) or other programmable logic device (PLD), discrete gate or transistor logic, discrete hardware components, or any combination thereof. The memory 338 may store data and program codes for operating the RF transceiver circuit 300. The controller 336 and/or memory 338 may include control logic. In certain cases, the controller 336 may determine a transmit power applied to the TX path 302 (e.g., certain levels of gain at the PA 318) that complies with an RF exposure limit set by domestic and/or international regulations and/or standards as further described herein.

### Example RF Exposure Compliance

RF exposure may be expressed in terms of a specific absorption rate (SAR), which measures energy absorption by human tissue per unit mass and may have units of watts per kilogram (W/kg). RF exposure may also be expressed in terms of power density (PD), which measures energy absorption per unit area and may have units of milliwatts per square centimeter (mW/cm²). In certain cases, a maximum permissible exposure (MPE) limit in terms of PD may be imposed for wireless communication devices using transmission frequencies above 6 GHz. The MPE limit is a regulatory metric for exposure based on area, e.g., an energy density limit defined as a number, X, watts per square meter (W/m²) averaged over a defined area and time-averaged over a frequency-dependent time window in order to prevent a human exposure hazard represented by a tissue temperature change.

SAR may be used in some configurations to assess RF exposure for transmission frequencies less than 6 GHz, which cover wireless communication technologies such as 2G/3G (e.g., CDMA), 4G (e.g., LTE), 5G (e.g., NR in 6 GHz bands), IEEE 802.11ac, etc. PD may be used in some configurations to assess RF exposure for transmission frequencies higher than 10 GHz, which cover wireless communication technologies such as IEEE 802.11ad, 802.11ay, 5G in mmWave bands, etc. Thus, different metrics may be used to assess RF exposure for different wireless communication technologies.

A wireless communication device (e.g., UE 120) may simultaneously transmit signals using multiple wireless communication technologies. For example, the wireless communication device may simultaneously transmit signals using a first wireless communication technology operating at or below 6 GHz (e.g., 3G, 4G, 5G, etc.) and a second wireless communication technology operating above 6 GHz (e.g., mmWave 5G in 24 to 60 GHz bands, IEEE 802.11ad or 802.11ay). In certain aspects, the wireless communication device may simultaneously transmit signals using the first wireless communication technology (e.g., 3G, 4G, 5G in sub-6 GHz bands, IEEE 802.11ac, etc.) in which RF exposure is measured in terms of SAR, and the second wireless communication technology (e.g., 5G in 24 to 60 GHz bands, IEEE 802.11ad, 802.11ay, etc.) in which RF exposure is measured in terms of PD. As used herein, sub-6 GHz bands may include frequency bands of 300 MHz to 6,000 MHz in some examples, and may include bands in the 6,000 MHz and/or 7,000 MHz range in some examples.

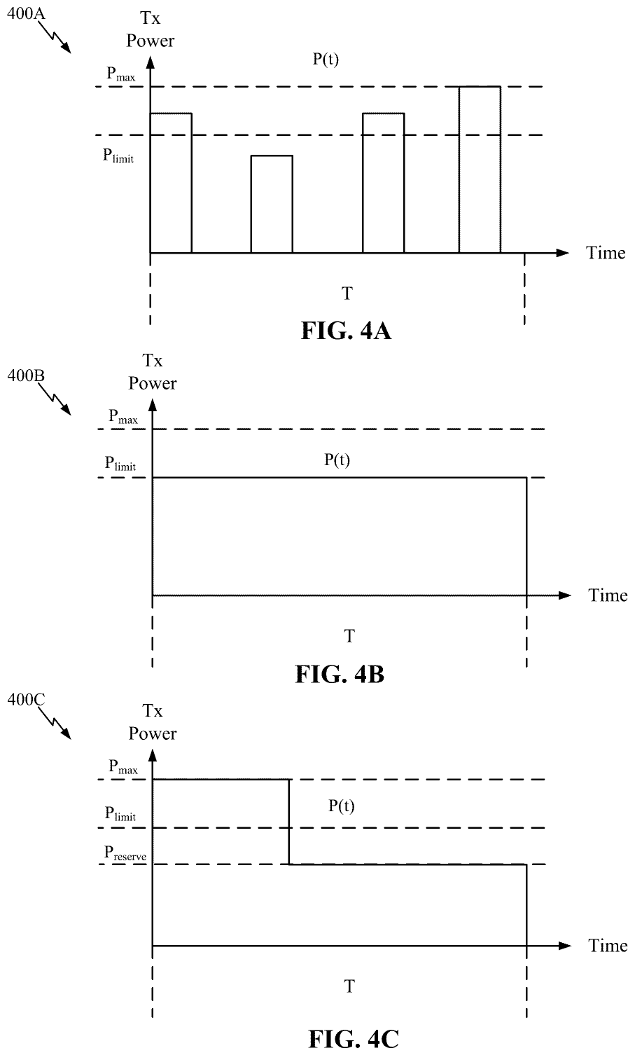

In certain cases, compliance with an RF exposure limit may be evaluated as a time-averaged RF exposure within a specified running time window (T) (e.g., 2 seconds for 60 GHz bands, 100 or 360 seconds for bands <6 GHz, etc.) associated with the RF exposure limit. For example, FIG. 4A is a graph 400A of a transmit power over time (P(t)) that varies over the time window (T) associated with the RF exposure limit, in accordance with certain aspects of the present disclosure. As an example, the instantaneous transmit power may exceed a maximum time-averaged transmit power level Pₗᵢₘᵢₜ in certain transmission occasions in the time window (T). That is, the transmit power may be greater than the maximum time-averaged transmit power level Pₗᵢₘᵢₜ. In certain cases, the UE may transmit at Pₘₐₓ, which is the maximum transmit power supported by the UE. In certain cases, the UE may transmit at a transmit power less than or equal to the maximum time-averaged transmit power level Pₗᵢₘᵢₜ in certain transmission occasions. The maximum time-averaged transmit power level Pₗᵢₘᵢₜ represents the time-averaged threshold in terms of transmit power for the RF exposure limit over the time window (T), and in certain cases, Pₗᵢₘᵢₜ may be referred to as the maximum time-averaged power level or limit, or in terms of exposure, the maximum time-averaged RF exposure level or limit. The graph 400A also illustrates gaps between transmission bursts, where the gaps represent periods during which no transmission was output from the device.

In certain cases, the transmit power may be maintained at the maximum time-averaged transmit power level (e.g., Pₗᵢₘᵢₜ) allowed for RF exposure compliance that enables continuous transmission during the time window. For example, FIG. 4B is a graph 400B of a transmit power over time (P(t)) illustrating an example where the transmit power is limited to Pₗᵢₘᵢₜ, in accordance with certain aspects of the present disclosure. As shown, the UE can transmit continuously at Pₗᵢₘᵢₜ in compliance with the RF exposure limit.

FIG. 4C is a graph 400C of a transmit power over time (P(t)) illustrating a time-averaged mode that provides a reserve power to enable a continuous transmission within the time window (T), in accordance with certain aspects of the present disclosure. As shown, the transmit power may be backed off from the maximum instantaneous power (Pₘₐₓ) to a reserve power (Preserve) so that the UE can continue transmitting at the lower power (Preserve) to maintain a continuous transmission during the time window (e.g., maintain a radio connection with a receiving entity). In FIG. 4C, the area between Pₘₐₓ and Pᵣₑₛₑᵣᵥₑ for the time duration of Pₘₐₓ may be equal to the area between Pₗᵢₘᵢₜ and Preserve for the time window T, such that the area of transmit power (P(t)) in FIG. 4C is equal to the area of Pₗᵢₘᵢₜ for the time window T. Such an area may be considered using 100% of the energy (transmit power or exposure) to remain compliant with the time-averaged RF exposure limit. Without the reserve power Pᵣₑₛₑᵣᵥₑ, the transmitter may transmit at Pₘₐₓ for a portion of the time window with the transmitter turned off for the remainder of the time window to ensure compliance with the time-averaged RF exposure limit. In some aspects, Pᵣₑₛₑᵣᵥₑ is set at a fixed power used to serve for a purpose (e.g., reserving power for certain communications). The transmit duration at Pₘₐₓ may be referred to as the burst transmit time (or high power duration). When more margin is available in the future (after T seconds), the transmitter may be allowed to transmit at a higher power again (e.g., in short bursts at Pₘₐₓ).

In some aspects, the UE may transmit at a power that is higher than the average power level, but less than Pₘₐₓ in the time-average mode illustrated in FIG. 4C. While a single transmit burst is illustrated in FIG. 4C, it will be understood that the UE may instead utilize a plurality of transmit bursts within the time window (T), for example, as described herein with respect to FIG. 4A, where the transmit bursts may be separated by periods during which the transmit power is maintained at or below Pᵣₑₛₑᵣᵥₑ. Further, it will be understood that the transmit power of each transmit burst may vary (either within the burst and/or in comparison to other bursts), and that at least a portion of the burst may be transmitted at a power above the maximum average power level (e.g., Pₗᵢₘᵢₜ).

While FIGS. 4A-4C illustrate continuous transmission over a window, occasion, burst, etc., it will be understood that a duty cycle for transmission may be implemented. In such implementations, a transmit power may be zero periodically and maintained at a higher level (e.g., a level as illustrated in FIGS. 4A-4C) during other portions of the duty cycle. As used herein, the duty cycle of the transmission may refer to a portion (e.g., 5 ms) of a specific period (e.g., 500 ms) in which one or more signals are transmitted. In certain cases, the duty cycle may be standardized (e.g., predetermined) with a specific RAT and/or vary over time, for example, due to changes in radio conditions, mobility, and/or user behavior.

### Example Transmit Antenna Grouping

In certain cases, the wireless device may evaluate RF exposure compliance in terms of one or more antenna groups, where an antenna group may be a collection of antennas and/or antenna modules. The antenna groups may be treated mutually exclusive of each other in terms of RF exposure. For example, the wireless device may evaluate the RF exposure compliance for an antenna group independently of the RF exposure compliance for another antenna group. The antenna groups may be static or dynamic. The antennas and/or antenna modules may support multiple RATs.

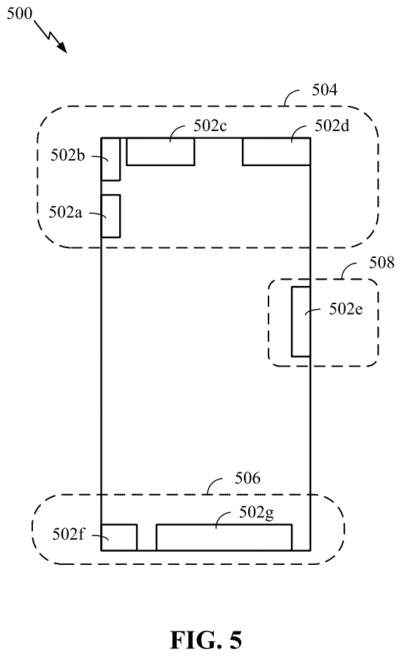

FIG. 5 is a block diagram illustrating an example grouping of multiple antennas of a wireless communication device 500, in accordance with certain aspects of the present disclosure. In this example, the wireless communication device 500 (e.g., a UE 120, such as a smartphone, or any of the wireless communication devices described herein) includes a first antenna 502a, a second antenna 502b, a third antenna 502c, a fourth antenna 502d, a fifth antenna 502e, a sixth antenna 502f, and a seventh antenna 502g. In this example, the antennas 502a-502g are separated into three antenna groups 504, 506, 508, which roughly correspond to a top of the device 500, a bottom of the device 500, and a side of the device 500, when the device 500 is held in the upright position. Those of skill in the art will appreciate that more or less than seven antennas may be implemented, and/or more or less than three antenna groupings may be defined. Each of the illustrated antennas 502a-502g may represent a single antenna, an array (e.g., a phased array) of antennas, or a module including one or more antennas. The antenna groups 504, 506, 508 may each include one or more antennas that are configured to transmit in a certain frequency band (e.g., very high (e.g., mmWave bands), high (e.g., 6-7 GHz bands), medium (e.g., 3-6 GHz bands), or low (e.g., 400 MHz-3 GHz bands)), or the antenna groups may each include one or more antennas that are configured to transmit in multiple frequency bands.

The antenna groupings described herein may be assigned into various antenna groupings (such as a mmWave grouping, a sub-6 GHz grouping, a low band grouping (e.g., 400 MHz-3 GHz bands), a mixed-mode grouping (e.g., mmWave and sub-6 GHz grouping), a multi-RAT grouping (e.g., WWAN and WLAN), groupings for different exposure scenarios and/or device positions relative to the user's body, etc.), for example, for differing transmit scenarios. As an example, under a mmWave grouping, each mmWave module (e.g., the first antenna 502a, the third antenna 502c, and the fifth antenna 502e) may be treated as a separate antenna group, where each mmWave module may have multiple antenna elements (e.g., 4, 5, 8, 10, etc. dual polarization antenna elements) arranged in one or more arrays. The mmWave module may be capable of transmitting various beams via predefined antenna configurations, where the beams may form a codebook. Under a sub-6 GHz grouping, sub-6 GHz antennas may be grouped into separate groups. For example, the second and fourth antennas 502b, 502d may be assigned to a group, and the sixth and seventh antennas 502f, 502g may be assigned to another group. In certain cases, the antennas 502a-502g may be assigned to a mixed-mode grouping, such as the three antenna groups 504, 506, 508. Each antenna may be included in a separate antenna group, as illustrated, or one or more antennas may be included in multiple antenna groups.

The antenna groups may be defined and/or operated so as to be mutually exclusive in terms of RF exposure. In certain aspects, the transmit power of one or more of the antenna groups (or of one or more of the antennas within one or more groups) may be reduced such that the (normalized) sum of the exposure of all antenna groups, or of the overlapped RF exposure distributions, is less than a particular value (e.g., 1.0). For example, backoff factors may be determined for one or more groups, or one or more antennas within one or more groups, and applied so as to limit transmission power for the antenna(s) and/or groups. In certain aspects, antennas in different antenna groups are far enough away from each other such that the antennas' exposures do not overlap in the range in which exposure to a user is measured or defined. In certain aspects, existing regulatory approaches that meet predefined criteria like SAR peak location separation ratio (SPLSR) may be used to determine such mutual exclusivity (for example, as described in Section 4.3.2c of the Federal Communications Commission (FCC) Knowledge Database (KDB) 447498 D01 General RF Exposure Guidance v06). The mutual exclusivity of the antenna groups may enable the RF exposure manager 122 or 281 to determine the time-averaged RF exposures for each of the antenna groups in parallel with (e.g., independent of) each other.

In some examples, antenna groups for a device (e.g., the wireless communication device 500) are defined in documents presented to and/or published by a regulatory body during the process of demonstrating or certifying that the device complies with RF exposure regulations.

The antenna groups are static in some examples. In other examples, the antenna groups change over time or based on the scenario.

### Example Service-Based Transmit Energy Allocation Among Different Radio Access Technologies

Multi-mode/multi-band UEs have multiple transmit antennas, which may be configured to simultaneously transmit in sub-6 GHz bands and bands greater than 6 GHz bands, such as mmWave bands. As described herein, the RF exposure of sub-6 GHz bands may be evaluated in terms of SAR, and the RF exposure of bands greater than 6 GHz may be evaluated in terms of PD. Due to the regulations on simultaneous exposure, the wireless device may limit maximum transmit power for both sub-6 GHz bands and bands greater than 6 GHz.

Certain aspects of the present disclosure provide apparatus and methods for allocating transmit energy among radios that communicate via different RATs based at least in part on services mapped to the radios. For example, a wireless communications device may use an RF exposure manager (e.g., RF exposure manager 122, RF exposure manager 281, etc.) to allocate a reserve transmit power (also referred to herein as simply a “reserve”) to each radio in an antenna group based at least in part on a current state of one or more services mapped to the radio, as described in greater detail herein. In certain cases, the radios in the antenna group may communicate via multiple RATs, including WWAN access technologies (e.g., LTE and 5G NR), WLAN access technologies (e.g., IEEE 802.11), and/or Bluetooth access technologies (e.g., Bluetooth version 4), as illustrative, non-limiting examples. In such cases, the reserve that is allocated to each respective radio may be further based on the particular RAT configured for that radio.

The apparatus and methods for allocating transmit energy among radios described herein may facilitate improved wireless communication performance (e.g., improved signal quality at the receiver, lower latencies, higher throughput, etc.). For example, a wireless device may allocate reserve to the radios based on services mapped to the radios, such that each radio has at least a minimum service reserve available for the service(s) mapped to the radio. Such an allocation may facilitate wireless communication performance by avoiding scenarios in which certain services are starved due to insufficient allocation of reserve.

In certain aspects, the wireless communications device may be configured with specific reserve information per service and antenna group, such as the antenna groups described herein with respect to FIG. 5. At least one of the antenna groups may be associated with three or more radios. The radios may communicate via two or more different RATs in some examples, where the different RATs may include, for example, a combination of WWAN and WLAN, a combination of WWAN and Bluetooth, or a combination of WWAN, WLAN, and Bluetooth. The reserve information may include, for each service supported by the wireless communication device, an indication of multiple minimum service reserves that should be allocated to the service, where each of the minimum service reserves is associated with a respective RAT. The wireless communications device may use the reserve information along with an indication of a current state associated with each respective service mapped to one or more radios to determine the portion of a reserve to allocate to the respective radio. Such a configuration may ensure that each service mapped to a given radio and in an active or parked state is allocated a sufficient amount of reserve to provide for a desired level of performance. Note, as used herein, a service in a “parked” state (or “park” mode) may refer to a service that is not currently active, but may start at any time. A service in an “active” state (or “active” mode) may refer to a service that is currently active.

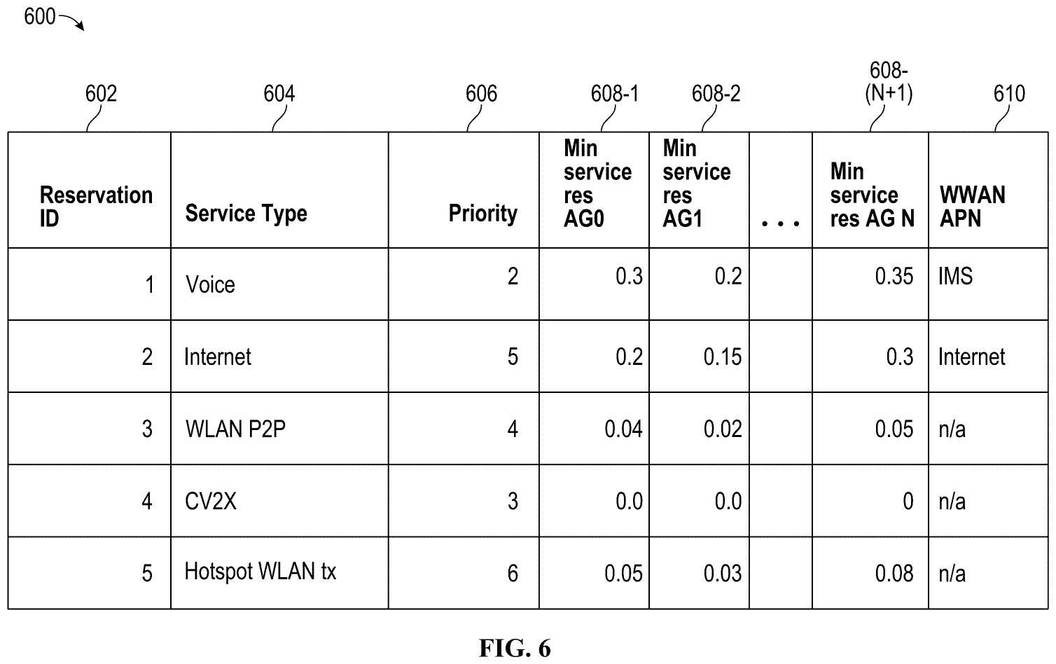

FIG. 6 is a table 600 illustrating example reserve information for multiple services for multiple antenna groups, according to certain aspects of the present disclosure. In certain aspects, the table 600 is a semi-static table, which may be configured by an original equipment manufacturer (OEM) of a wireless communications device.

In this example, each row in the table 600 corresponds to a different service (or service type), such as voice traffic, Internet traffic, WLAN P2P traffic, CV2X traffic, and hotspot WLAN traffic, as illustrative, non-limiting examples. For each row, the table 600 includes a reservation identifier (ID) field 602, a service type field 604, a priority field 606, one or more minimum service reserve fields 608, and a WWAN access point name (APN) field 610.

The reservation ID field 602 includes a unique identifier for the respective service type. In table 600, for example, voice traffic has a reservation ID=“1,” Internet traffic has a reservation ID=“2,” WLAN P2P traffic has a reservation ID=“3,” CV2X traffic has a reservation ID=“4,” and hotspot WLAN traffic has a reservation ID=“5.” These numbers are just examples, and different numbers may be used to represent the various service types. Note that while FIG. 6 depicts the reservation ID field 602 having an integer data type, other data types (e.g., alphanumeric data type, string data type, etc.) are also contemplated.

The service type field 604 is generally a string that indicates the particular service type (e.g., voice traffic, Internet traffic, WLAN P2P traffic, CV2X traffic, and hotspot WLAN traffic, as illustrated). Note that the services depicted in table 600 are provided as reference examples of services that can be configured for a wireless communication device and that the table 600 can include any number of services as well as different types of services. In some examples, the service type field 604 is omitted.

The priority field 606 includes an indication of a priority level for each respective service. In table 600, for example, voice traffic has a priority level of 2, Internet traffic has a priority level of 5, WLAN P2P traffic has a priority level of 4, CV2X traffic has a priority level of 3, and hotspot WLAN traffic has a priority level of 6, where the priority levels are in an ascending order of priority (that is, a lower priority level number indicates a relatively higher priority service). Note, however, that in other examples, the table 600 may include priority levels in a descending order of priority (where a higher priority level number indicates a relatively higher priority service). In yet other examples, indications of priority level other than numbers may be used, such as other alphanumeric characters or strings.

The minimum service reserve fields 608-1 to 608-(N+1) (collectively, minimum service reserve fields 608) indicate, for each service, an amount of reserve that should be allocated to the service for each antenna group (e.g., AG0 to AGN). For example, since different antenna groups may have different RF exposure limits (e.g., Pₗᵢₘᵢₜ), the minimum service reserve for a given service may be different for each antenna group. Thus, the varying reserves in table 600 may be representative of varying conditions that might exist for different radios and/or antennas in different antenna groups. Further, services might have differing priorities and/or transmission specifications depending on an antenna or radio used to operate with that service. In general, the table 600 includes an indication of the reserve for a service on all the antenna groups where that service can take place. The values in the minimum service reserve fields 608 may be listed in terms of normalized exposure (NE) reserve levels, which may be expressed as the minimum service reserve transmission power divided by Pₗᵢₘᵢₜ or another suitable value. A value of 0 (or another suitable indication) in the minimum service reserve fields 608 may be used to indicate that a certain service does not use a particular antenna group or that this service is in an off state.

Note, there may be instances where, within an antenna group, the minimum service reserve for a service on radio X (in the antenna group) may be different than the minimum service reserve for the service on radio Y (in the antenna group). In such instances, the table 600 may set the minimum service reserve for the antenna group to the maximum of the minimum service reserves for radios where a service can appear in the antenna group. Note, however, that in such instances, the table 600 may set the minimum service reserve for the antenna group according to another criteria, such as priority of the radios, as an illustrative example. In other examples, reserve information is additionally or alternatively provided in the table 600 for individual radios within the same antenna group. For instance, assuming a service is mapped to a radio X and a radio Y in the same antenna group, the table 600 may include the minimum service reserve for the service on radio X and the minimum service reserve for the service on radio Y within the antenna group.

The WWAN APN field 610 may be included for a service when the service is mapped to WWAN. For example, a radio that supports a WWAN access technology may support one or more different WWAN RATs, such as 5G NR, LTE, Universal Mobile Telecommunications System (UMTS), Internet Protocol (IP) Multimedia Subsystem (IMS), and CDMA (e.g., 2G/3G RAT). Additionally, for uplink carrier aggregation in LTE and/or NR, each of the active component carriers used for wireless communications may be treated as a separate radio. For example, LTE and/or NR may support a master cell group (MCG) and a secondary cell group (SCG), where each of the MCG and SCG supports a primary component carrier (PCC) and one or more secondary component carriers (SCCs). Accordingly, when the WWAN APN field 610 is included for a service, the WWAN APN field 610 generally includes an indication of the particular WWAN radio to which the service is mapped.

In the example depicted in table 600, the WWAN APN field 610 for voice traffic indicates “IMS,” and the WWAN APN field 610 for Internet traffic indicates “Internet.” The wireless communications device may use the WWAN APN information to allocate the minimum service reserve to the appropriate radio for the service. For example, if the WWAN APN field indicates “IMS,” then the service may use the IMS bearer. The IMS bearer may be radio resource control (RRC) configured on the MCG/SCG in LTE or the MCG/SCG in NR. Assuming MCG is used, IMS may refer to the LTE PCC or FR1 PCC. Thus, when the WWAN APN field indicates “IMS,” the wireless communications device may assume that the radio is LTE PCC or FR1 PCC.

In other examples, if the WWAN APN field 610 indicates “Internet,” then the service may use the default bearer. The data link layer (e.g., in the open systems interconnection (OSI) model) can establish MCG and SCG for the default bearer along with the bearer type (e.g., LTE, FR1, and FR2). Accordingly, in this example, the wireless communications device may assume that the service occurs on both PCC and SCC (of MCG and SCG if present). Thus, the value in the APN field need not represent an access point, but rather can represent a bearer or any other type of information that can be used to identify a radio configured for a service on a particular RAT (e.g., a radio in WWAN used for the service).

In certain aspects, the wireless communications device may generate real-time information about the state of each service (e.g., reservation ID field 602) indicated in the reserve information (e.g., table 600). In some examples, the real-time state information may be generated by an RF exposure manager (e.g., RF exposure manager 122, RF exposure manager 281, etc.) of the wireless communications device. In other examples, the real-time state information may be generated at run-time using a communication interface, such as a mobile station modem (MSM) interface. In yet other examples, the real-time state information may be generated at run-time by an applications processor.

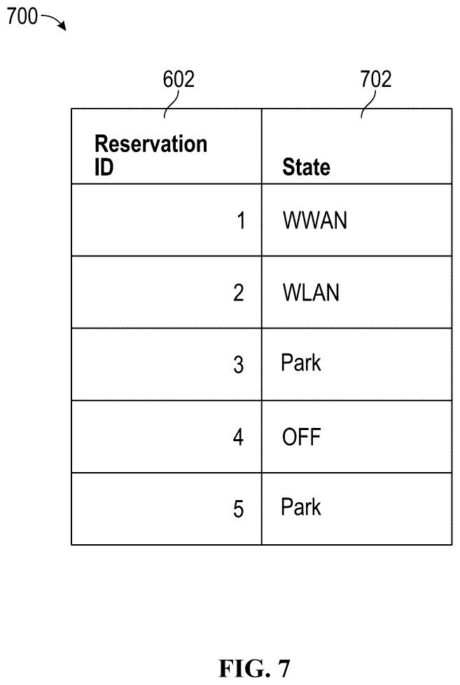

FIG. 7 is a table 700 illustrating real-time state information for multiple services, according to certain aspects of the present disclosure. Here, the table 700 indicates a real-time state 702 for each service (e.g., each reservation ID field 602) indicated in the table 600. In this example, the real-time state 702 for each service may have one of the following values: (i) “WWAN”—the service is currently active on WWAN; (ii) “WLAN”—the service is currently active on WLAN; (iii) “BT”—the service is currently active on Bluetooth; (iv) “Park”—the service is not currently active, but may start at any time; and (v) “Off”—the service is currently disabled on the device and not expected to start. Such disablement may be temporary, or may be due to the device not supporting that service. Note, however, that the aforementioned state values are merely examples and that the real-time state for each service may have other values (e.g., to indicate other RATs that the service is currently active on).

In the depicted example in FIG. 7, the table 700 indicates that voice traffic (e.g., reservation ID=1) is currently active on WWAN, Internet traffic (e.g., reservation ID=2) is currently active on WLAN, WLAN P2P traffic (e.g., reservation ID=3) is parked, CV2X traffic (e.g., reservation ID=4) is off, and hotspot WLAN traffic (e.g., reservation ID=5) is parked.

In certain aspects, the wireless communications device may map a reserve to each radio based on the reserve information (e.g., table 600) and the current (e.g., real-time) state of each service (e.g., table 700) mapped to the radio.

In some aspects, when there is a single service mapped to a single radio, the minimum service reserve for that service/antenna group is allocated to the single radio. For example, for voice traffic on a PCC radio, the minimum service reserve for voice traffic for the antenna group that includes the PCC radio is allocated to the PCC radio. In other examples, for Internet traffic on a WLAN radio, the minimum service reserve for Internet traffic for the antenna group that includes the WLAN radio is allocated to the WLAN radio. In yet other examples, for Bluetooth traffic on a Bluetooth radio, the minimum service reserve for Bluetooth traffic for the antenna group that includes the Bluetooth radio is allocated to the Bluetooth radio.

In some aspects, when there are multiple services mapped to a single radio, the single radio may be allocated a sum of the minimum service reserves for the multiple services. For example, if both voice traffic and Internet traffic are on the PCC radio, then the PCC radio may be allocated a sum of (i) the minimum service reserve for voice traffic for the antenna group that includes the PCC radio and (ii) the minimum service reserve for Internet traffic for the antenna group that includes the PCC radio.

In certain cases, a lookup of the WWAN radio based on the APN (e.g., lookup_wwan_radio (APN)) may return more than one radio (e.g., PCC and SCC in LTE). In some aspects, when there is a single service mapped to multiple radios in the same antenna group, each radio may be allocated a respective portion of the minimum service reserve for the service. For example, assuming Internet traffic is mapped to the PCC radio and SCC radio in the same antenna group, the PCC radio may be allocated a portion of the minimum service reserve for Internet traffic for the antenna group, and the SCC radio may be allocated another portion of the minimum service reserve for Internet traffic for the antenna group. The minimum service reserve may be allocated equally between the multiple radios or in accordance with any suitable ratio (e.g. a preconfigured ratio).

In some aspects, when there is a single service mapped to multiple radios in different antenna groups, each radio may be allocated the entire minimum service reserve for the service for the respective antenna group. For example, assuming Internet traffic is mapped to the PCC radio in a first antenna group and the SCC radio in a second antenna group, the PCC radio may be allocated the minimum service reserve for Internet traffic for the first antenna group, and the SCC radio may be allocated the minimum service reserve for Internet traffic for the second antenna group. Alternatively, in some aspects, when there is a single service mapped to multiple radios in different antenna groups, each radio may be allocated a portion of the minimum service reserve for the service for the respective antenna group.

In certain aspects, the wireless communications device may map a priority to each radio based at least in part on the reserve information (e.g., table 600) and the current (e.g., real-time) state of each service (e.g., table 700) mapped to the radio. In some aspects, when there is a single service mapped to a single radio, the single radio may be assigned the priority of the single service. In other aspects, when there are multiple services mapped to a single radio, the single radio may be assigned the highest priority among the multiple services. In yet other aspects, when there is a single service mapped to multiple radios, each of the multiple radios may share the same priority of the single service.

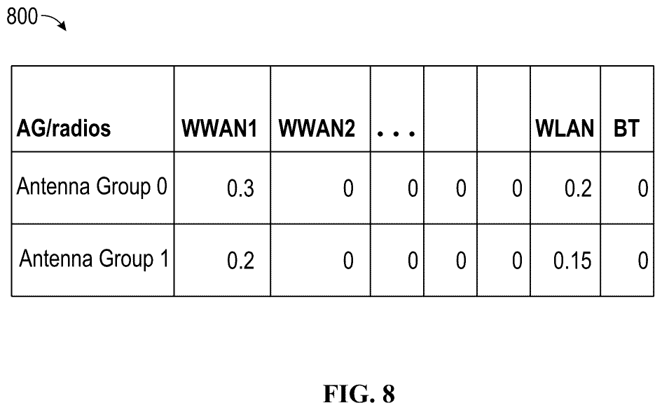

FIG. 8 is a table 800 illustrating an example of minimum service reserve/priority mapped to radios of one or more antenna groups, according to certain aspects of the present disclosure. The table 800 may be generated based on the reserve information (e.g., table 600) and real-time state information (e.g., table 700).

In this example, for antenna group 0 (AG0), since voice traffic (e.g., reservation ID=1) is currently active on WWAN (e.g., state==WWAN in table 700), a WWAN1 radio in AG0 is allocated the minimum service reserve (e.g., 0.3) corresponding to voice traffic and AG0 in the reserve information (e.g., table 600). Similarly, for AG1, the WWAN1 radio in AG1 is allocated the minimum service reserve (e.g., 0.2) corresponding to voice traffic and AG1 in the reserve information (e.g., table 600). Additionally, the WWAN1 radio is given a priority level of “2” based on the priority of the voice traffic in the reserve information.

As further shown, for AG0, since Internet traffic (e.g., reservation ID=2) is currently active on WLAN (e.g., state==WLAN in table 700), the WLAN radio in AG0 is allocated the minimum service reserve (e.g., 0.2) corresponding to Internet traffic and AG0 in the reserve information (e.g., table 600). Similarly, for AG1, the WLAN radio in AG1 is allocated the minimum service reserve (e.g., 0.15) corresponding to Internet traffic and AG1 in the reserve information (e.g., table 600). Additionally, the WLAN radio is given a priority level of “5” based on the priority of the Internet traffic in the reserve information.

In certain aspects, the reserve for a service may be held (or parked) before the service starts. Doing so allows a new service to start anytime since the minimum service reserve has been parked or held for this new service's operation. In some aspects, the normalized exposure of the total minimum service reserve (NE_{totalMinRsv}) that is held for a respective antenna group in a given time interval may be equal to the sum of the minimum service reserves (min.service.res) for all service types supported in the antenna group. For example, for AG0 in table 600, NE_{totalMinRsv} is equal to 0.3 (for voice traffic in active mode)+0.2 (for Internet traffic in active mode)+0.04 (for WLAN P2P traffic in park mode)+0.05 (for hotspot WLAN traffic in park mode)=0.59. In this example, for reservation ID=3 and reservation ID=5, the minimum service reserve of 0.04 and 0.05, respectively, is parked for a total of 0.09 minimum service reserve parked for the time interval.

In certain aspects, one or more radios with active services may be allowed to use unused reserve from parked services. For example, assuming the 0.09 minimum service reserve (from parked services) is unused in a given time interval, the 0.09 minimum service reserve may be allocated to one or more radios with active services in a subsequent time interval.

While tables are illustrated in FIGS. 6-8, such structures are not required. The information in these figures may be generated, stored, and/or accessed in any number of different ways. In some examples, data structures corresponding to the tables in FIGS. 6-8 are stored in the memory 282 or one or more memories associated with the controller/processor 280.

### Example Operations for Wireless Communication

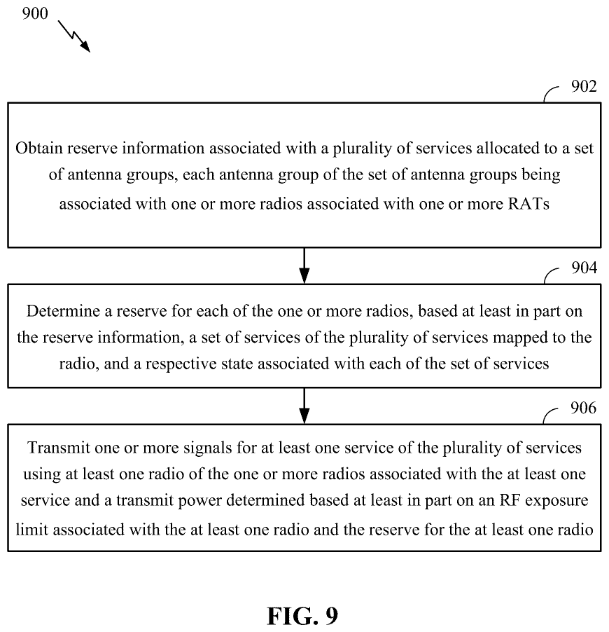

FIG. 9 is a flow diagram illustrating example operations 900 for wireless communication, in accordance with certain aspects of the present disclosure. The operations 900 may be performed, for example, by a wireless device (e.g., the UE 120a in the wireless communication network 100). The operations 900 may be implemented as software components that are executed and run on one or more processors (e.g., controller/processor 280 of FIG. 2). For example, an RF exposure manager (e.g., RF exposure manager 122, RF exposure manager 281, etc.) implemented via the one or more processors may perform the operations 900 or a subset thereof. Further, the transmission and/or reception of signals by the wireless device in the operations 900 may be enabled, for example, by one or more antennas (e.g., antennas 252 of FIG. 2). In certain aspects, the transmission and/or reception of signals by the wireless device may be implemented via a bus interface of one or more processors (e.g., controller/processor 280) obtaining and/or outputting signals.

The operations 900 may optionally begin, at block 902, where the wireless device may obtain reserve information (e.g., table 600) associated with multiple services allocated to a set of antenna groups. Each antenna group of the set of antenna groups may be associated with one or more radios associated with one or more RATs. In certain aspects, the RATs may include WWAN, WLAN, Bluetooth, NTN technologies (e.g., satellite communications), RFID communications, sidelink communications, V2X communications, or a combination thereof. The wireless device may obtain the reserve information via memory. For example, the reserve information (e.g., table 600) may be stored in memory (e.g., the memory 282 and/or the memory 338), and the wireless device may access the memory to obtain the reserve information.

The reserve information (e.g., table 600) may include various parameters associated with determining the reserve for a particular radio. The wireless device may be configured with reserve information for each service per antenna group. For example, the reserve information may indicate multiple minimum service reserves for each service of multiple services, where each minimum service reserve is associated with a respective antenna group of a set of antenna groups. The reserve information may also indicate a respective priority for each of the multiple services.

At block 904, the wireless device determines a reserve for each of the one or more radios, based at least in part on the reserve information, a set of services of the multiple services mapped to the radio, and a respective state associated with each of the set of services. The reserve for each of the one or more radios may be a minimum level of transmit power allocated to the respective radio for a time window associated with the RF exposure limit. Additionally, in certain aspects, the reserve for each of the one or more radios may be determined prior to a start of the time window.

The respective state associated with each of the set of services may be determined in real time. For example, the wireless device may obtain the respective state information (e.g., table 700) via memory or may generate the respective state information at run-time. The state information may indicate, for each of the set of services, whether the service is in active mode, park mode, or off (or disabled). In certain aspects, the set of services that are mapped to the respective radio may include one or more services having a respective state in active mode or park mode.

In certain aspects, the determination (in block 904) may include, for each radio: determining a sum of the respective minimum service reserves that are associated with (i) the set of services mapped to the radio and (ii) the antenna group that includes the radio; and determining the reserve for the radio to be equal to the sum of the minimum service reserves.

In certain aspects, the determination (in block 904) may include, for a single service of the multiple services mapped to a first radio of the one or more radios and a second radio of the one or more radios: determining the reserve for the first radio to be equal to a first portion of a respective minimum service reserve for the single service; and determining the reserve for the second radio to be equal to a second portion of the respective minimum service reserve for the single service, where the first radio and the second radio are in the same antenna group.

In certain aspects, the wireless device may determine that the reserve for a particular radio is set to zero, for example, when all of the services allocated to that radio are in an off state.

The reserve for each of the radios may correspond to a minimum level of transmit power allocated to the respective radio for a certain duration, for example, a transmission occasion, a time window associated with the RF exposure limit, and/or a time interval of the time window. The reserve for a given radio may be allocated by the time-averaging RF exposure algorithm for the entire duration of an active radio's operating time window (e.g., 2 seconds, 100 seconds, or 360 seconds depending on the transmission frequency and respective time window of the RF exposure limit). When evaluating the running time average (the reserve in a time slot rolling out of a time window may be the same as the reserve for a time slot rolling into the time window), the reserve may be preserved continuously for the entire duration of a transmission, e.g., indefinitely. It may be assumed that the transmission can continue indefinitely and provide reserve indefinitely, which may be accomplished by allocating the reserve for the entire duration of the active radio's time window associated with the RF exposure limit.

In certain aspects, the wireless device may determine the reserve information periodically or in response to one or more events. For example, the reserve information may be determined periodically every time window associated with the time-averaged RF exposure limit. In some cases, the reserve information may be determined in response to detecting the occurrence of a specific event, such as when the wireless device is powered on, when the wireless device detects a change in radio conditions, when the wireless device detects a change in the number of radios in the active state, etc. In some cases, the reserve information may be preconfigured.

At block 906, the wireless device transmits one or more signals for at least one service of the plurality of services using at least one radio of the one or more radios associated with the at least one service and a transmit power determined based at least in part on a radio frequency (RF) exposure limit associated with the at least one radio and the reserve for the at least one radio. For example, the wireless device may determine a transmit power that satisfies the RF exposure limit, where the transmit power for the radio corresponds to at least the reserve for the respective radio. In certain cases, the RF exposure limit may include a maximum time-averaged RF exposure limit, for example, as described herein with respect to FIGS. 4A-4C and/or all transmissions may be allocated a transmit power at or above (greater than or equal to) the reserve.

In some aspects, the at least one service (in block 906) is a single service that is mapped to a single radio of the one or more radios. In other aspects, the at least one service (in block 906) includes at least two services mapped to a plurality of the one or more radios. In yet other aspects, the at least one service (in block 906) is a single service that is mapped to a plurality of the one or more radios.

In certain aspects, the operations 900 further include determining a priority for each of the one or more radios, based at least in part on the reserve information and the set of services mapped to the radio. In some aspects, when the set of services includes a single service mapped to a single radio of the one or more radios, the priority of the single radio is determined to be equal to the priority of the single service. In other aspects, when the set of services includes multiple services mapped to a single radio of the one or more radios, the priority for the single radio is determined to be equal to the highest priority of the multiple services. In yet other aspects, when the set of services includes a single service mapped to multiple radios, the priority of each radio is determined to be equal to the priority of the single service. In certain aspects, the wireless communication device may use the priority information to arbitrate requests for reserve from the radios. For example, the priority information can be used to determine the order in which each radio is allocated its minimum service reserve. If insufficient power is available to allocate minimum service reserves to all radios based on all active and parked services, the minimum service reserve for a lower priority service may not be allocated, or the minimum service reserve for a (lower priority) parked service may not be allocated. Further, if power remains after allocating minimum service reserves to all radios based on all active and parked services, excess power may be distributed based on priority.

The operations 900 may be performed per antenna group. The wireless device may be configured with reserve information per antenna group and apply the corresponding reserve information to a particular antenna group when the antenna group is actively transmitting. As the antenna groups may be configured to be mutually exclusive of each other in terms of RF exposure, the operations 900 may be performed independently for each of the antenna groups. For example, the operations 900 may be performed simultaneously for another antenna group.

The wireless device may be configured with multiple sets of antenna groups, and the wireless device may have different reserve information configured per antenna group among the multiple sets of antenna groups. For example, the wireless device may have an antenna group (or a set of antenna groups) configured for a particular exposure scenario (e.g., head exposure), and another antenna group (or another set of antenna groups) configured for a different exposure scenario (e.g., hand and body exposure). The wireless device may select the antenna group for the corresponding exposure scenario, and the wireless device may select the reserve information associated with the respective antenna group.

While the examples depicted in FIGS. 1-9 are described herein with respect to a UE performing the various methods for providing RF exposure compliance to facilitate understanding, aspects of the present disclosure may also be applied to other wireless devices, such as a wireless station, an access point, a base station and/or a customer premises equipment (CPE), performing the RF exposure compliance described herein. Further, while the examples are described with respect to communications between the UE (or other wireless device) and a network entity, the UE or other wireless device may be communicating with a device other than a network entity, for example another UE or with another device in a user's home that is not a network entity, for example.

It will be appreciated that the service-based allocation of transmit energy among radios described herein may enable desirable wireless communication performance, such as reduced latencies, increased uplink data rates, and/or an uplink connection at the edge of a cell.

### Example Communications Device

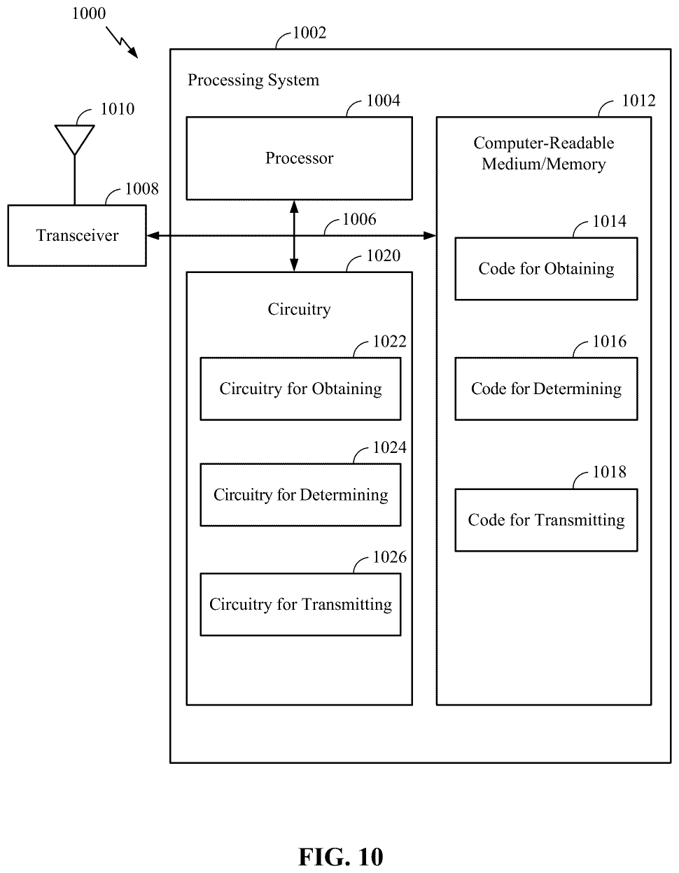

FIG. 10 illustrates a communications device 1000 (e.g., the UE 120) that may include various components (e.g., corresponding to means-plus-function components) configured to perform operations for the techniques disclosed herein, such as the operations illustrated in FIG. 9. The communications device 1000 includes a processing system 1002, which may be coupled to a transceiver 1008 (e.g., a transmitter and/or a receiver). The transceiver 1008 is configured to transmit and receive signals for the communications device 1000 via an antenna 1010, such as the various signals as described herein. The processing system 1002 may be configured to perform processing functions for the communications device 1000, including processing signals received and/or to be transmitted by the communications device 1000.

The processing system 1002 includes a processor 1004 coupled to a computer-readable medium/memory 1012 via a bus 1006. In certain aspects, the computer-readable medium/memory 1012 is configured to store instructions (e.g., computer-executable code) that when executed by the processor 1004, cause the communications device 1000 to perform the operations 900 illustrated in FIG. 9, or other operations for performing the various techniques discussed herein for providing RF exposure compliance. In certain aspects, computer-readable medium/memory 1012 stores code for obtaining 1014, code for determining 1016, code for transmitting (or outputting) 1018, or any combination thereof.

In certain aspects, the processing system 1002 has circuitry 1020 configured to implement the code stored in the computer-readable medium/memory 1012. In certain aspects, the circuitry 1020 is coupled to the processor 1004 and/or the computer-readable medium/memory 1012 via the bus 1006. For example, the circuitry 1020 includes circuitry for obtaining 1022, circuitry for determining 1024, circuitry for transmitting (or outputting) 1026, or any combination thereof.

In some examples, means for transmitting or sending (or means for outputting for transmission) may include the transceivers 254 and/or antenna(s) 252 of the UE 120 illustrated in FIG. 2 and/or transceiver 1008 and antenna 1010 of the communications device 1000 in FIG. 10.

In some cases, rather than actually transmitting, for example, signals and/or data, a device may have an interface to output signals and/or data for transmission (a means for outputting). For example, a processor may output signals and/or data, via a bus interface, to a radio frequency (RF) front end for transmission. Similarly, rather than actually receiving signals and/or data, a device may have an interface to obtain the signals and/or data received from another device (a means for obtaining). For example, a processor may obtain (or receive) the signals and/or data, via a bus interface, from an RF front end for reception. In various aspects, an RF front end may include various components, including transmit and receive processors, transmit and receive MIMO processors, modulators, demodulators, and the like, such as depicted in the examples in FIG. 2.

In some examples, means for obtaining and/or means for determining may include various processing system components, such as: the processor 1004 in FIG. 10, or aspects of the UE 120 depicted in FIG. 2, including receive processor 258, transmit processor 264, TX MIMO processor 266, and/or controller/processor 280.

### Example Aspects

Implementation examples are described in the following numbered clauses:

Clause 1: A method of wireless communication by a wireless device, comprising: obtaining reserve information associated with a plurality of services allocated to a set of antenna groups, each antenna group of the set of antenna groups being associated with one or more radios corresponding to one or more radio access technologies (RATs); determining a reserve for each of the one or more radios, based at least in part on the reserve information, a set of services of the plurality of services mapped to the radio, and a respective state associated with each of the set of services; and transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

Clause 2: The method of Clause 1, wherein: the reserve information indicates a plurality of minimum service reserves for each of the plurality of services; and each of the plurality of minimum service reserves is associated with a respective antenna group of the set of antenna groups.

Clause 3: The method of Clause 2, wherein determining the reserve for each of the one or more radios comprises, for each radio: determining a sum of the respective minimum service reserves that are associated with (i) the set of services mapped to the radio and (ii) the antenna group that includes the radio; and determining the reserve for the radio to be equal to the sum of the minimum service reserves.

Clause 4: The method according to any of Clauses 1-3, wherein the set of services mapped to the radio includes one or more services having a respective state in active mode or park mode.

Clause 5: The method of Clause 2, wherein determining the reserve for each of the one or more radios comprises, for a single service of the plurality of services mapped to a first radio of the one or more radios and a second radio of the one or more radios: determining the reserve for the first radio to be equal to a first portion of a respective minimum service reserve for the single service; and determining the reserve for the second radio to be equal to a second portion of the respective minimum service reserve for the single service, wherein the first radio and the second radio are in the same antenna group.

Clause 6: The method according to any of Clauses 1-5, wherein: the reserve for each of the one or more radios is a minimum level of transmit power allocated to the respective radio for a time window associated with the RF exposure limit; and the reserve for each of the one or more radios is determined prior to a start of the time window.

Clause 7: The method according to any of Clauses 1-6, wherein the reserve information indicates a respective priority for each of the plurality of services.

Clause 8: The method of Clause 7, further comprising determining a priority for each of the one or more radios, based at least in part on the reserve information and the set of services mapped to the radio.

Clause 9: The method of Clause 8, wherein: the set of services comprises a single service mapped to a single radio of the one or more radios; and determining the priority for each of the one or more radios comprises determining the priority for the single radio to be equal to the priority of the single service.

Clause 10: The method of Clause 8, wherein: the set of services comprises a plurality of services mapped to a single radio of the one or more radios; and determining the priority for each of the one or more radios comprises: determining which of the plurality of services has a highest priority; and determining the priority for the single radio to be equal to the highest priority.

Clause 11: The method of Clause 8, wherein: the set of services comprises a single service mapped to a plurality of radios of the one or more radios; and determining the priority for each of the one or more radios comprises determining the priority for each of the radios to be equal to the priority of the single service.

Clause 12: The method according to any of Clauses 1-11, wherein the at least one service is a single service that is mapped to a single radio of the one or more radios.

Clause 13: The method according to any of Clauses 1-11, wherein the at least one service comprises at least two services mapped to a plurality of the one or more radios.

Clause 14: The method according to any of Clauses 1-11, wherein the at least one service is a single service that is mapped to a plurality of the one or more radios.

Clause 15: An apparatus comprising: one or more memories collectively storing computer-executable instructions, and one or more processors coupled to the one or more memories, the one or more processors being collectively configured to execute the computer-executable instructions to cause the apparatus to perform a method in accordance with any of Clauses 1-14.

Clause 16: An apparatus for wireless communication, comprising means for performing a method in accordance with any of Clauses 1-14.

Clause 17: A non-transitory computer-readable medium comprising computer-executable instructions that, when collectively executed by one or more processors of a processing system, cause the processing system to perform a method in accordance with any of Clauses 1-14.

Clause 18: A computer program product embodied on a computer-readable storage medium comprising code for performing a method in accordance with any of Clauses 1-14.

### Additional Considerations

The techniques described herein may be used for various wireless communication technologies, such as NR (e.g., 5G NR), Long Term Evolution (LTE), LTE-Advanced (LTE-A), code division multiple access (CDMA), time division multiple access (TDMA), frequency division multiple access (FDMA), orthogonal frequency division multiple access (OFDMA), single-carrier frequency division multiple access (SC-FDMA), time division synchronous code division multiple access (TD-SCDMA), and other networks. The terms “network” and “system” are often used interchangeably. A CDMA network may implement a radio technology such as Universal Terrestrial Radio Access (UTRA), cdma2000, etc. UTRA includes Wideband CDMA (WCDMA) and other variants of CDMA. cdma2000 covers IS-2000, IS-95, and IS-856 standards. A TDMA network may implement a radio technology such as Global System for Mobile Communications (GSM). An OFDMA network may implement a radio technology such as NR (e.g., 5G RA), Evolved UTRA (E-UTRA), Ultra Mobile Broadband (UMB), IEEE 802.11 (Wi-Fi), IEEE 802.16 (WiMAX), IEEE 802.20, Flash-OFDMA, etc. UTRA and E-UTRA are part of Universal Mobile Telecommunication System (UMTS). LTE and LTE-A are releases of UMTS that use E-UTRA. UTRA, E-UTRA, UMTS, LTE, LTE-A and GSM are described in documents from an organization named “3rd Generation Partnership Project” (3GPP). cdma2000 and UMB are described in documents from an organization named “3rd Generation Partnership Project 2” (3GPP2). NR is an emerging wireless communications technology under development.

In 3GPP, the term “cell” can refer to a coverage area of a Node B (NB) and/or a NB subsystem serving this coverage area, depending on the context in which the term is used. In NR systems, the term “cell” and BS, next generation NodeB (gNB or gNodeB), access point (AP), distributed unit (DU), carrier, or transmission reception point (TRP) may be used interchangeably. A BS may provide communication coverage for a macro cell, a pico cell, a femto cell, and/or other types of cells. A macro cell may cover a relatively large geographic area (e.g., several kilometers in radius) and may allow unrestricted access by UEs with service subscription. A pico cell may cover a relatively small geographic area and may allow unrestricted access by UEs with service subscription. A femto cell may cover a relatively small geographic area (e.g., a home) and may allow restricted access by UEs having an association with the femto cell (e.g., UEs in a closed subscriber group (CSG), UEs for users in the home, etc.). A BS for a macro cell may be referred to as a macro BS. A BS for a pico cell may be referred to as a pico BS. A BS for a femto cell may be referred to as a femto BS or a home BS.

A UE may also be referred to as a mobile station, a terminal, an access terminal, a subscriber unit, a station, a customer premises equipment (CPE), a cellular phone, a smart phone, a personal digital assistant (PDA), a wireless modem, a wireless device, a handheld device, a laptop computer, a cordless phone, a wireless local loop (WLL) station, a tablet computer, a camera, a gaming device, a netbook, a smartbook, an ultrabook, an appliance, a medical device or medical equipment, a biometric sensor/device, a wearable device such as a smart watch, smart clothing, smart glasses, a smart wristband, smart jewelry (e.g., a smart ring, a smart bracelet, etc.), an entertainment device (e.g., a music device, a video device, a satellite radio, etc.), a vehicular component or sensor, a smart meter/sensor, industrial manufacturing equipment, a global positioning system device, or any other suitable device that is configured to communicate via a wireless or wired medium. Some UEs may be considered machine-type communication (MTC) devices or evolved MTC (eMTC) devices. MTC and eMTC UEs include, for example, robots, drones, remote devices, sensors, meters, monitors, location tags, etc., that may communicate with a BS, another device (e.g., remote device), or some other entity. A wireless node may provide, for example, connectivity for or to a network (e.g., a wide area network such as Internet or a cellular network) via a wired or wireless communication link. Some UEs may be considered Internet-of-Things (IoT) devices, which may be narrowband IoT (NB-IoT) devices.

In some examples, access to the air interface may be scheduled. A scheduling entity (e.g., a BS) allocates resources for communication among some or all devices and equipment within the scheduling entity's service area or cell. The scheduling entity may be responsible for scheduling, assigning, reconfiguring, and releasing resources for one or more subordinate entities. That is, for scheduled communication, subordinate entities utilize resources allocated by the scheduling entity. Base stations are not the only entities that may function as a scheduling entity. In some examples, a UE may function as a scheduling entity and may schedule resources for one or more subordinate entities (e.g., one or more other UEs), and the other UEs may utilize the resources scheduled by the UE for wireless communication. In some examples, a UE may function as a scheduling entity in a peer-to-peer (P2P) network, and/or in a mesh network. In a mesh network example, UEs may communicate directly with one another in addition to communicating with a scheduling entity.

The methods disclosed herein comprise one or more steps or actions for achieving the methods. The method steps and/or actions may be interchanged with one another without departing from the scope of the claims. In other words, unless a specific order of steps or actions is specified, the order and/or use of specific steps and/or actions may be modified without departing from the scope of the claims.

As used herein, “a processor,” “at least one processor,” or “one or more processors” generally refers to a single processor configured to perform one or multiple operations or multiple processors configured to collectively perform one or more operations. In the case of multiple processors, performance of the one or more operations could be divided amongst different processors, though one processor may perform multiple operations, and multiple processors could collectively perform a single operation. Similarly, “a memory,” “at least one memory,” or “one or more memories” generally refers to a single memory configured to store data and/or instructions or multiple memories configured to collectively store data and/or instructions.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, generating, investigating, looking up (e.g., looking up in a table, a database or another data structure), ascertaining, and the like. Also, “determining” may include receiving (e.g., receiving information), accessing (e.g., accessing data in a memory), and the like. Also, “determining” may include resolving, selecting, choosing, establishing, and the like.

The previous description is provided to enable any person skilled in the art to practice the various aspects described herein. Various modifications to these aspects will be readily apparent to those skilled in the art, and the generic principles defined herein may be applied to other aspects. Thus, the claims are not intended to be limited to the aspects shown herein, but is to be accorded the full scope consistent with the language of the claims, wherein reference to an element in the singular is not intended to mean “one and only one” unless specifically so stated, but rather “one or more.” Unless specifically stated otherwise, the term “some” refers to one or more. All structural and functional equivalents to the elements of the various aspects described throughout this disclosure that are known or later come to be known to those of ordinary skill in the art are expressly incorporated herein by reference and are intended to be encompassed by the claims. Moreover, nothing disclosed herein is intended to be dedicated to the public regardless of whether such disclosure is explicitly recited in the claims. No claim element is to be construed under the provisions of 35 U.S.C. § 112(f) unless the element is expressly recited using the phrase “means for” or, in the case of a method claim, the element is recited using the phrase “step for.”

The various operations of methods described above may be performed by any suitable means capable of performing the corresponding functions. The means may include various hardware and/or software component(s) and/or module(s), including, but not limited to a circuit, an application specific integrated circuit (ASIC), or processor. Generally, where there are operations illustrated in figures, those operations may have corresponding counterpart means-plus-function components with similar numbering.

The various illustrative logical blocks, modules and circuits described in connection with the present disclosure may be implemented or performed with a general purpose processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, or any other such configuration.

If implemented in hardware, an example hardware configuration may comprise a processing system in a wireless node. The processing system may be implemented with a bus architecture. The bus may include any number of interconnecting buses and bridges depending on the specific application of the processing system and the overall design constraints. The bus may link together various circuits including a processor, machine-readable media, and a bus interface. The bus interface may be used to connect a network adapter, among other things, to the processing system via the bus. The network adapter may be used to implement the signal processing functions of the physical (PHY) layer. In the case of a UE (see FIG. 1), a user interface (e.g., keypad, display, mouse, joystick, etc.) may also be connected to the bus. The bus may also link various other circuits such as timing sources, peripherals, voltage regulators, power management circuits, and the like, which are well known in the art, and therefore, will not be described any further. The processor may be implemented with one or more general-purpose and/or special-purpose processors. Examples include microprocessors, microcontrollers, DSP processors, and other circuitry that can execute software. Those skilled in the art will recognize how best to implement the described functionality for the processing system depending on the particular application and the overall design constraints imposed on the overall system.

If implemented in software, the functions may be stored or transmitted over as one or more instructions or code on a computer-readable medium. Software shall be construed broadly to mean instructions, data, or any combination thereof, whether referred to as software, firmware, middleware, microcode, hardware description language, or otherwise. Computer-readable media include both computer storage media and communication media including any medium that facilitates transfer of a computer program from one place to another. The processor may be responsible for managing the bus and general processing, including the execution of software modules stored on the machine-readable storage media. A computer-readable storage medium may be coupled to a processor such that the processor can read information from, and write information to, the storage medium. In the alternative, the storage medium may be integral to the processor. By way of example, the machine-readable media may include a transmission line, a carrier wave modulated by data, and/or a computer-readable storage medium with instructions stored thereon separate from the wireless node, all of which may be accessed by the processor through the bus interface. Alternatively, or in addition, the machine-readable media, or any portion thereof, may be integrated into the processor, such as the case may be with cache and/or general register files. Examples of machine-readable storage media may include, by way of example, RAM (Random Access Memory), flash memory, ROM (Read-Only Memory), PROM (Programmable Read-Only Memory), EPROM (Erasable Programmable Read-Only Memory), EEPROM (Electrically Erasable Programmable Read-Only Memory), registers, magnetic disks, optical disks, hard drives, or any other suitable storage medium, or any combination thereof. The machine-readable media may be embodied in a computer program product.

A software module may comprise a single instruction, or many instructions, and may be distributed over several different code segments, among different programs, and across multiple storage media. The computer-readable media may comprise a number of software modules. The software modules include instructions that, when executed by an apparatus such as a processor, cause the processing system to perform various functions. The software modules may include a transmission module and a receiving module. Each software module may reside in a single storage device or be distributed across multiple storage devices. By way of example, a software module may be loaded into RAM from a hard drive when a triggering event occurs. During execution of the software module, the processor may load some of the instructions into cache to increase access speed. One or more cache lines may then be loaded into a general register file for execution by the processor. When referring to the functionality of a software module below, it will be understood that such functionality is implemented by the processor when executing instructions from that software module.

Also, any connection is properly termed a computer-readable medium. For example, if the software is transmitted from a website, server, or other remote source using a coaxial cable, fiber optic cable, twisted pair, digital subscriber line (DSL), or wireless technologies such as infrared (IR), radio, and microwave, then the coaxial cable, fiber optic cable, twisted pair, DSL, or wireless technologies such as infrared, radio, and microwave are included in the definition of medium. Disk and disc, as used herein, include compact disc (CD), laser disc, optical disc, digital versatile disc (DVD), floppy disk, and Blu-ray® disc where disks usually reproduce data magnetically, while discs reproduce data optically with lasers. Thus, in some aspects computer-readable media may comprise non-transitory computer-readable media (e.g., tangible media). In addition, for other aspects computer-readable media may comprise transitory computer-readable media (e.g., a signal). Combinations of the above should also be included within the scope of computer-readable media.

Thus, certain aspects may comprise a computer program product for performing the operations presented herein. For example, such a computer program product may comprise a computer-readable medium having instructions stored (and/or encoded) thereon, the instructions being executable by one or more processors to perform the operations described herein, for example, instructions for performing the operations described herein and illustrated in FIG. 9.

Further, it should be appreciated that modules and/or other appropriate means for performing the methods and techniques described herein can be downloaded and/or otherwise obtained by a user terminal and/or base station as applicable. For example, such a device can be coupled to a server to facilitate the transfer of means for performing the methods described herein. Alternatively, various methods described herein can be provided via storage means (e.g., RAM, ROM, or a physical storage medium such as a compact disc (CD) or floppy disk, etc.), such that a user terminal and/or base station can obtain the various methods upon coupling or providing the storage means to the device. Moreover, any other suitable technique for providing the methods and techniques described herein to a device can be utilized.

It is to be understood that the claims are not limited to the precise configuration and components illustrated above. Various modifications, changes, and variations may be made in the arrangement, operation, and details of the methods and apparatus described above without departing from the scope of the claims.

1. A method of wireless communication by a wireless device, comprising:
obtaining reserve information associated with a plurality of services allocated to a set of antenna groups, each antenna group of the set of antenna groups being associated with one or more radios corresponding to one or more radio access technologies (RATs);
determining a reserve for each of the one or more radios, based at least in part on the reserve information, a set of services of the plurality of services mapped to the radio, and a respective state associated with each of the set of services; and
transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

2. The method of claim 1, wherein:
the reserve information indicates a plurality of minimum service reserves for each of the plurality of services; and
each of the plurality of minimum service reserves is associated with a respective antenna group of the set of antenna groups.

3. The method of claim 2, wherein determining the reserve for each of the one or more radios comprises, for each radio:
determining a sum of the respective minimum service reserves that are associated with (i) the set of services mapped to the radio and (ii) the antenna group that includes the radio; and
determining the reserve for the radio to be equal to the sum of the minimum service reserves.

4. The method of claim 3, wherein the set of services mapped to the radio includes one or more services having a respective state in active mode or park mode.

5. The method of claim 2, wherein determining the reserve for each of the one or more radios comprises, for a single service of the plurality of services mapped to a first radio of the one or more radios and a second radio of the one or more radios:
determining the reserve for the first radio to be equal to a first portion of a respective minimum service reserve for the single service; and
determining the reserve for the second radio to be equal to a second portion of the respective minimum service reserve for the single service, wherein the first radio and the second radio are in the same antenna group.

6. The method of claim 1, wherein:
the reserve for each of the one or more radios is a minimum level of transmit power allocated to the respective radio for a time window associated with the RF exposure limit; and
the reserve for each of the one or more radios is determined prior to a start of the time window.

7. The method of claim 1, wherein the reserve information indicates a respective priority for each of the plurality of services.

8. The method of claim 7, further comprising determining a priority for each of the one or more radios, based at least in part on the reserve information and the set of services mapped to the radio.

9. The method of claim 8, wherein:
the set of services comprises a single service mapped to a single radio of the one or more radios; and
determining the priority for each of the one or more radios comprises determining the priority for the single radio to be equal to the priority of the single service.

10. The method of claim 8, wherein:
the set of services comprises a plurality of services mapped to a single radio of the one or more radios; and
determining the priority for each of the one or more radios comprises:
determining which of the plurality of services has a highest priority; and
determining the priority for the single radio to be equal to the highest priority.

11. The method of claim 8, wherein:
the set of services comprises a single service mapped to a plurality of radios of the one or more radios; and
determining the priority for each of the one or more radios comprises determining the priority for each of the radios to be equal to the priority of the single service.

12. The method of claim 1, wherein the at least one service is a single service that is mapped to a single radio of the one or more radios.

13. The method of claim 1, wherein the at least one service comprises at least two services mapped to a plurality of the one or more radios.

14. The method of claim 1, wherein the at least one service is a single service that is mapped to a plurality of the one or more radios.

15. An apparatus for wireless communication, comprising:
one or more memories collectively storing computer-executable instructions; and
one or more processors coupled to the one or more memories, the one or more processors being collectively configured to execute the computer-executable instructions to cause the apparatus to perform an operation comprising:
obtaining reserve information associated with a plurality of services allocated to a set of antenna groups, each antenna group of the set of antenna groups being associated with one or more radios corresponding to one or more radio access technologies (RATs);
determining a reserve for each of the one or more radios, based at least in part on the reserve information, a set of services of the plurality of services mapped to the radio, and a respective state associated with each of the set of services; and
transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

16. The apparatus of claim 15, wherein:
the reserve information indicates a plurality of minimum service reserves for each of the plurality of services; and
each of the plurality of minimum service reserves is associated with a respective antenna group of the set of antenna groups.

17. The apparatus of claim 16, wherein determining the reserve for each of the one or more radios comprises, for each radio:
determining a sum of the respective minimum service reserves that are associated with (i) the set of services mapped to the radio and (ii) the antenna group that includes the radio; and
determining the reserve for the radio to be equal to the sum of the minimum service reserves.

18. The apparatus of claim 17, wherein the set of services mapped to the radio includes one or more services having a respective state in active mode or park mode.

19. The apparatus of claim 16, wherein determining the reserve for each of the one or more radios comprises, for a single service of the plurality of services mapped to a first radio of the one or more radios and a second radio of the one or more radios:
determining the reserve for the first radio to be equal to a first portion of a respective minimum service reserve for the single service; and
determining the reserve for the second radio to be equal to a second portion of the respective minimum service reserve for the single service, wherein the first radio and the second radio are in the same antenna group.

20. The apparatus of claim 15, wherein:
the reserve for each of the one or more radios is a minimum level of transmit power allocated to the respective radio for a time window associated with the RF exposure limit; and
the reserve for each of the one or more radios is determined prior to a start of the time window.

21. The apparatus of claim 15, wherein the reserve information indicates a respective priority for each of the plurality of services.

22. The apparatus of claim 21, the operation further comprising determining a priority for each of the one or more radios, based at least in part on the reserve information and the set of services mapped to the radio.

23. The apparatus of claim 22, wherein:
the set of services comprises a single service mapped to a single radio of the one or more radios; and
determining the priority for each of the one or more radios comprises determining the priority for the single radio to be equal to the priority of the single service.

24. The apparatus of claim 22, wherein:
the set of services comprises a plurality of services mapped to a single radio of the one or more radios; and
determining the priority for each of the one or more radios comprises:
determining which of the plurality of services has a highest priority; and
determining the priority for the single radio to be equal to the highest priority.

25. The apparatus of claim 22, wherein:
the set of services comprises a single service mapped to a plurality of radios of the one or more radios; and
determining the priority for each of the one or more radios comprises determining the priority for each of the radios to be equal to the priority of the single service.

26. The apparatus of claim 15, wherein the at least one service is a single service that is mapped to a single radio of the one or more radios.

27. The apparatus of claim 15, wherein the at least one service comprises at least two services mapped to a plurality of the one or more radios.

28. The apparatus of claim 15, wherein the at least one service is a single service that is mapped to a plurality of the one or more radios.

29. An apparatus for wireless communication, comprising:
means for obtaining reserve information associated with a plurality of services allocated to a set of antenna groups, each antenna group of the set of antenna groups being associated with one or more radios corresponding to one or more radio access technologies (RATs);
means for determining a reserve for each of the one or more radios, based at least in part on the reserve information, a set of services of the plurality of services mapped to the radio, and a respective state associated with each of the set of services; and
means for transmitting one or more signals for at least one service of the plurality of services using at least one radio of the one or more radios associated with the at least one service and a transmit power determined based at least in part on a radio frequency (RF) exposure limit associated with the at least one radio and the reserve for the at least one radio.

30. A non-transitory computer-readable medium having instructions stored thereon, which when executed by one or more processors, cause the one or more processors to perform an operation comprising:
obtaining reserve information associated with a plurality of services allocated to a set of antenna groups, each antenna group of the set of antenna groups being associated with one or more radios corresponding to one or more radio access technologies (RATs);
determining a reserve for each of the one or more radios, based at least in part on the reserve information, a set of services of the plurality of services mapped to the radio, and a respective state associated with each of the set of services; and
causing transmission of one or more signals for at least one service of the plurality of services using at least one radio of the one or more radios associated with the at least one service and a transmit power determined based at least in part on a radio frequency (RF) exposure limit associated with the at least one radio and the reserve for the at least one radio.
